(19) United States
(12) Patent Application Publication
(10) Pub. No.: US 2024/0103525 A1
(43) Pub. Date: Mar. 28, 2024

(54) VEHICLE AND CONTROL METHOD THEREOF

(71) Applicants: Hyundai Motor Company, Seoul (KR); Kia Corporation, Seoul (KR)

(72) Inventor: Junghyun LEE, Seoul (KR)

(73) Assignees: Hyundai Motor Company, Seoul (KR); Kia Corporation, Seoul (KR)

(21) Appl. No.: 18/205,241

(22) Filed: Jun. 2, 2023

(30) Foreign Application Priority Data
Sep. 27, 2022 (KR) 10-2022-0122569

(51) Int. Cl. G05D 1/02; G06T 7/60

(52) U.S. Cl. CPC G05D 1/0246; G06T 7/60; B60W 2420/42; G06T 2207/30244

(57) ABSTRACT

A control method of a vehicle includes: setting, as a template, an area around a vanishing point in a previous frame of an image input from a camera; determining a matching area matching with the template by performing template matching in a current frame; determining an amount of position change of the vanishing point based on an amount of position change between the template and the matching area; estimating a change amount in a pose of the camera based on the amount of position change of the vanishing point; and estimating a pose of the vehicle depending on the change amount in pose of the camera.

### CROSS-REFERENCE TO RELATED APPLICATION

The present application claims priority to Korean Patent Application No. 10-2022-0122569, filed on Sep. 27, 2022, the entire contents of which is incorporated herein for all purposes by this reference.

### BACKGROUND OF THE PRESENT DISCLOSURE

### Field of the Present Disclosure

The present disclosure relates to a vehicle and a control method thereof which may estimate a pose of a camera using an image input by the camera mounted on the vehicle while driving.

### Description of Related Art

Cameras are essentially mounted on a vehicle provided with an advanced driver assistance system (ADAS) for autonomous driving, collision warning, and the like.

Such vehicles recognize an object through cameras, obtain information related to the object, and obtain an object's location using the obtained information.

When a vehicle recognizes an object through a camera, a vehicle's pose may be changed by topography of a road. In the present instance, an error may occur in a distance measured through image processing.

Vehicle dynamic compensation (VDC) is performed to compensate for a distance error caused by a change in pose of a camera depending on topography of a road. VDC estimates the change amount in camera pose due to a change in vehicle pose, estimates the vehicle pose based on the change amount in camera pose, and compensates for a distance error using the vehicle pose.

In existing VDC, a vehicle pose is estimated based on a vanishing point in an image input by a camera while driving. That is, the change amount in camera pose is estimated based on a position of a vanishing point in an input image, and a vehicle pose is estimated based on the change amount in camera pose.

Conventionally, however, when a vanishing point may not be detected, the change amount in camera pose may not be estimated, causing inaccurate and unreliable estimation of vehicle pose.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle and a control method thereof which may estimate the change amount in camera pose using template matching on an area around a vanishing point in an image, estimating a pose of the vehicle more accurately and reliably.

Additional aspects of the present disclosure will be set forth in part in the description which follows, and in part, will be obvious from the description, or may be learned by practice of the present disclosure.

According to an aspect of the present disclosure, there is provided a control method of a vehicle including: setting, as a template, an area around a vanishing point in a previous frame of an image input from a camera; determining a matching area matching with the template by performing template matching in a current frame; determining an amount of position change of the vanishing point based on an amount of position change between the template and the matching area; estimating a change amount in a pose of the camera based on the amount of position change of the vanishing point; and estimating a pose of the vehicle depending on the change amount in pose of the camera.

The setting of the area around the vanishing point as the template may include changing a position of the template based on a variance value of the template.

The setting of the area around the vanishing point as the template may include determining a reliability of the template based on the variance value of the template, and changing the position of the template, based on the reliability of the template being low.

The changing of the position of the template may include moving the template according to a slope of a horizontal line based on a roll angle at which the camera is mounted.

The changing of the position of the template may include moving the template according to the slope of the horizontal line in a direction opposite to a driving direction of the vehicle.

The changing of the position of the template may include moving the template upward, based on a driving direction of the vehicle not being recognized or the vehicle going straight.

The setting of the area around the vanishing point as the template may include changing a size of the template based on a speed of the vehicle.

The determining of the matching area may include performing the template matching using a normalized cross correlation matching.

The determining of the matching area may include performing the template matching using the normalized cross correlation matching in a current frame consecutive from the previous frame.

The camera is a front camera configured to obtain image data for a field of view facing a front of the vehicle, and the determining of the amount of position change of the vanishing point may include: determining a change amount in y-axis of the template based on the amount of position change between the template and the matching area, and determining a change amount in y-axis of the vanishing point based on a change amount in y-axis where a roll slope at which the front camera is mounted is compensated from the change amount in y-axis of the template.

The estimating of the change amount in a pose of the camera may include estimating an amount of pitch change of the front camera based on the change amount in y-axis of the vanishing point.

The estimating of the pose of the vehicle may include estimating a pitch pose of the vehicle based on the amount of pitch change of the front camera.

The camera is a multi-camera configured to obtain image data for a field of view facing a plurality of directions of the vehicle, and the estimating of the change amount in a pose of the camera may include: fusing an amount of position change of a vanishing point corresponding to each camera of the multi-camera, estimating a change amount in pose of each of the cameras of the multi-camera based on the fused amount of position change of the vanishing point, and estimating the pose of the vehicle based on the estimated change amount in the pose of each of the cameras.

The estimating of the pose of the vehicle may include estimating the pose of the vehicle as at least one of rolling, pitching, yawing, height, or going straight.

According to an aspect of the present disclosure, there is provided a vehicle including: a camera configured to photograph an area around of the vehicle; and a controller electrically connected to the camera, wherein the controller may be configured to: set, as a template, an area around a vanishing point in a previous frame of an image input from the camera, determine a matching area matching with the template by performing template matching in a current frame, determine an amount of position change of the vanishing point based on an amount of position change between the template and the matching area, estimate a change amount in a pose of the camera based on the amount of position change of the vanishing point, and estimate a pose of the vehicle depending on the change amount in pose of the camera.

The controller may be configured to change a position of the template based on a variance value of the template.

The controller may be configured for determining a movement direction of the template based on a driving direction of the vehicle and a roll angle at which the camera is mounted, and move the template in the determined movement direction.

The camera is a front camera configured to obtain image data for a field of view facing a front of the vehicle, and the controller may be configured to: determine a change amount in y-axis of the template based on the amount of position change between the template and the matching area, determine a change amount in y-axis of the vanishing point based on a change amount in y-axis where a roll slope at which the front camera is mounted is compensated from the change amount in y-axis of the vanishing point, estimate an amount of pitch change of the front camera based on the change amount in y-axis of the vanishing point, and estimate a pitch pose of the vehicle based on the amount of pitch change of the front camera.

The camera is a multi-camera configured to obtain image data for a field of view facing a plurality of directions of the vehicle, and the controller may be configured to: fuse an amount of position change of a vanishing point corresponding to each camera of the multi-camera, estimate a change amount in pose of each of the cameras of the multi-camera based on the fused amount of position change of the vanishing point, and estimate the pose of the vehicle based on the estimated change amount in the pose of each of the cameras.

The controller may be configured for estimating the pose of the vehicle as at least one of rolling, pitching, yawing, height, or going straight.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an arrangement of a plurality of cameras mounted on a vehicle according to an exemplary embodiment of the present disclosure;

FIG. 2 is a control block diagram illustrating a vehicle according to an exemplary embodiment of the present disclosure;

FIG. 3 and FIG. 4 are diagrams illustrating a distance error due to a change in pose of a vehicle according to an exemplary embodiment of the present disclosure;

FIG. 5 is a diagram illustrating detecting a vanishing point in a front image by a vehicle according to an exemplary embodiment of the present disclosure;

FIG. 6 is a diagram illustrating estimating the change amount in pose of a front camera based on a vanishing point in a front image by a vehicle according to an exemplary embodiment of the present disclosure;

FIG. 7 is a flowchart illustrating a control method of a vehicle according to an exemplary embodiment of the present disclosure;

FIG. 8 is a diagram illustrating setting an area around a vanishing point as a template by a vehicle according to an exemplary embodiment of the present disclosure;

FIG. 9 is a diagram illustrating changing a position of a template by a vehicle according to an exemplary embodiment of the present disclosure;

FIG. 10 is a diagram illustrating determining the amount of position change of a vanishing point by performing template matching in a vehicle according to an exemplary embodiment of the present disclosure;

FIG. 11 are top view images when a vehicle pose estimated using template matching is applied and is not applied, in a vehicle according to an exemplary embodiment of the present disclosure;

FIG. 12 illustrates a road width standard deviation, an average road width, and an included angle between two lanes when a vehicle pose estimated using template matching is applied and is not applied, in a vehicle according to an exemplary embodiment of the present disclosure;

FIG. 13 is a diagram illustrating estimating a pose of a vehicle using multi-cameras by the vehicle according to another exemplary embodiment of the present disclosure; and

FIG. 14 is a diagram illustrating a relationship between a movement direction of vanishing point for each camera and a pose of a vehicle in the vehicle according to another exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals throughout the specification denote like elements. Also, the present specification does not describe all the elements according to various exemplary embodiments of the present disclosure, and descriptions well-known in the art to which the present disclosure pertains or overlapped portions are omitted. The terms such as “—part”, “—member”, “—module”, “—device”, and the like may refer to at least one process processed by at least one hardware or software. According to various exemplary embodiments of the present disclosure, a plurality of “parts”, “—members”, “—modules”, “—devices” may be embodied as a single element, or a single of a “part”, “—member”, “—module”, “—device” may include a plurality of elements.

It will be understood that when an element is referred to as being “connected” to another element, it may be directly or indirectly connected to the other element, wherein the indirect connection includes “connection” via a wireless communication network.

It will be understood that the term “include” when used in the present specification, specifies the presence of stated features, integers, steps, operations, elements, and/or components, but does not preclude the presence or addition of at least one other features, integers, steps, operations, elements, components, and/or groups thereof.

It will be understood that when it is stated in the present specification that a member is located “on” another member, not only a member may be in contact with another member, but also yet another member may be present between the two members.

It will be understood that, although the terms first, second, etc. may be used herein to describe various elements, these elements should not be limited by these terms. It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

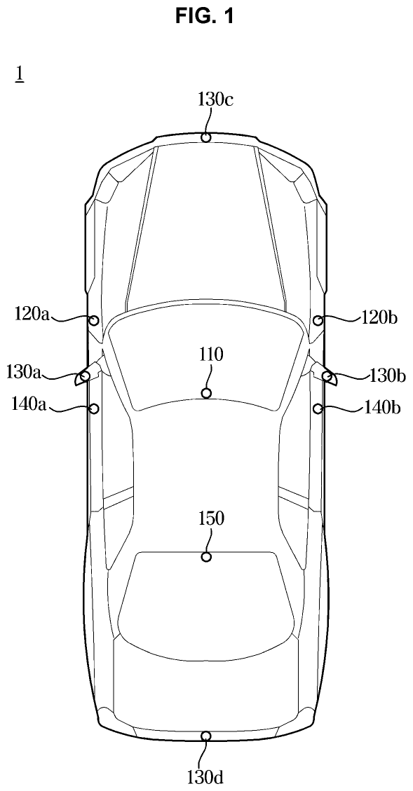

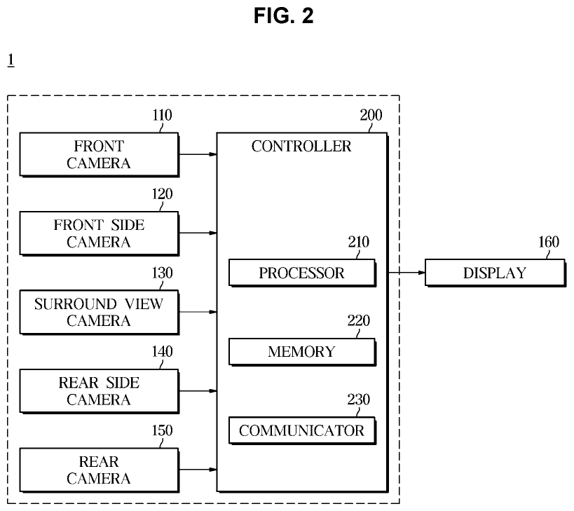

FIG. 1 is a diagram illustrating an arrangement of a plurality of cameras mounted on a vehicle according to an exemplary embodiment of the present disclosure. FIG. 2 is a control block diagram illustrating a vehicle according to an exemplary embodiment of the present disclosure.

Referring to FIG. 1 and FIG. 2, a vehicle 1 may assist a driver in operating (driving, braking, and steering) the vehicle 1. For example, the vehicle 1 may detect surroundings around the vehicle 1 (e.g., other vehicles, pedestrians, cyclists, lanes, traffic signs, and the like), and control the vehicle's driving and/or braking and/or steering in response to the detected surroundings. Hereinafter, an object includes any kind of object which may collide with the vehicle 1 in motion, such as another vehicle, cyclist, and the like.

The vehicle 1 may provide a variety of functions to the driver. For example, the vehicle 1 may provide the driver with functions for an autonomous driving system such as a lane departure warning (LDW), a lane keeping assist (LKA), a high beam assist (HBA), an autonomous emergency braking (AEB), a traffic sign recognition (TSR), a smart cruise control (SCC), a blind spot detection (BSD), and the like.

As shown in FIG. 1, the vehicle 1 may include at least one camera. To perform the above functions, the vehicle 1 may be provided with a radar and a laser imaging, detection, and ranging (LiDAR), in addition to the camera.

The at least one camera may include a charge-coupled device (CCD) or complimentary metal-oxide-semiconductor (CMOS) image sensor, and a three-dimensional (3D) space recognition sensor such as a KINECT (RGB-D sensor), Time of flight (TOF) sensor, stereo camera, etc.

The at least one camera may be provided at different positions on the vehicle 1.

For example, the at least one camera may include a front camera 110, front side camera 120 (120a and 120b), surround view camera 130 (130a, 130b, 130c and 130d), rear side camera 140 (140a and 140b), and a rear camera 150.

The front camera 110 may be provided on a front windshield glass of the vehicle 1 to secure a front field of view. The front camera 110 may photograph a front of the vehicle 1 and obtain image data of the front of the vehicle 1. The front camera 110 may detect a moving object in front, or an object travelling in adjacent lanes in front lateral fields of view. Front image data of the vehicle 1 may include location information of at least one of other vehicles, pedestrians, cyclists, lanes, curbs, guardrails, street trees, or streetlights located in front of the vehicle 1.

The front side camera 120 (120a and 120b) may be provided on the front left and right sides of the vehicle 1 such as the A pillar, B pillar, and the like, of the vehicle 1 to secure the front left and right fields of view. The front side camera 120 may photograph the front left and right sides of the vehicle 1, and obtain image data of the front left and right sides of the vehicle 1.

The surround view camera 130 (130a, 130b, 130c and 130d) may be provided on side mirrors of the vehicle 1 to secure fields of view toward left and right sides (or lower left and right sides) of the vehicle 1, and be provided on each of a front bumper and a rear bumper of the vehicle 1 to secure fields of view toward front and rear sides (or lower front and rear sides) of the vehicle 1. The surround view camera 130 may photograph the left and right sides (or lower left and right sides) and front and rear sides (or lower front and rear sides) of the vehicle 1, and obtain image data of the left and right sides (or lower left and right sides) and front and rear sides (or lower front and rear sides) of the vehicle 1.

The rear side camera 140 (140a and 140b) may be provided on rear left and right sides of the vehicle 1 such as a C pillar of the vehicle 1, to secure rear left and right fields of view. The rear side camera 140 may photograph the rear left and right sides of the vehicle 1 and obtain image data of the rear left and right sides of the vehicle 1.

The rear camera 150 may be provided on a rear side of the vehicle, such as a rear bumper, and the like, of the vehicle 1 to secure a rear field of view. The rear camera 150 may photograph a rear of the vehicle 1 and obtain image data of the rear of the vehicle 1.

Hereinafter, for convenience of description, at least two of the front camera 110, the front side camera 120 (120a and 120b), the surround view camera 130 (130a, 130b, 130c and 130d), the rear side camera 140 (140a and 140b), or the rear camera 150 are referred to as ‘multi-camera’. Although a multi-camera system including ten cameras is illustrated in FIG. 1, the number of cameras may be changed.

As shown in FIG. 2, the vehicle 1 may include a display 160.

The display 160 may display surroundings around the vehicle 1 as an image. Here, the image may be an image photographed by a monocular camera or a multi-camera.

The display 160 may display a location of an obstacle around the vehicle 1.

The display 160 may display notification information related to collision warning.

The display 160 may display a top view image. Here, the top view image is also referred to as an around-view image or a bird's eye view image.

The display 160 may display a top view image in which a distance error between an actual distance and a recognized distance to an object in an image is corrected.

The display 160 may further include an image sensor and a system on chip (SOC) for converting analog signals into digital signals, controlling and image processing.

The display 160 may be provided as a cathode ray tube (CRT), a digital light processing (DLP) panel, a plasma display panel (PDP), liquid crystal display (LCD) panel, electro luminescence (EL) panel, electrophoretic display (EPD) panel, electrochromic display (ECD) panel, light-emitting diode (LED) panel, organic LED (OLED) panel, and the like, without being limited thereto.

The vehicle 1 may include a controller 200 performing overall control on the vehicle 1.

The controller 200 may obtain a plurality of images photographed by the multi-camera, and generate a stereoscopic image by considering a geometric relationship among the plurality of images. In the present instance, the controller 200 may obtain more physical information related to an object than an image photographed by a monocular camera.

The controller 200 may include an image signal processor 210, which is a processor 210 processing image data of the multi-camera, and/or a micro control unit (MCU) generating a braking signal, and the like.

When an autonomous driving system is in operation, the controller 200 may identify objects in an image based on image data obtained by the front camera 110, and compare information related to the identified objects and object information stored in a memory 220, determining whether the objects in the image are stationary or moving.

The stationary objects may include street trees, streetlights, lanes, speed bumps, traffic signs, and the like. The moving objects may include other vehicles, pedestrians, cyclists, bikes, and the like.

When processing image data of the front camera 200, the controller 200 may estimate the change amount in pose of the front camera, and estimate a pose of the vehicle based on the estimated change amount in pose of the front camera. The controller 200 may be configured to generate a front image in which a distance error is corrected, based on the pose of the vehicle, and display the generated front image on the display 160.

When processing image data of the multi-camera, the controller 200 may estimate the change amount in pose of each camera of the multi-camera, and estimate a pose of the vehicle by collecting the estimated change amount in pose of each of the cameras of the multi-camera. The controller 200 may be configured to generate a top view image in which a distance error is corrected based on the pose of the vehicle, and display the generated top view image on the display 160.

The memory 220 may store a program and/or data for processing image data, a program and/or data for processing radar data, and a program and/or data for the processor 210 to generate a braking signal, a steering signal, and/or a warning signal.

The memory 220 may temporarily store image data received from the monocular camera and/or image data received from the multi-camera, and temporarily store a processing result of the radar data and/or the image data of the memory 220.

The memory 220 may store steering information, braking information, sensing information related to movement of the vehicle such as a transmission system, and the like.

The memory 220 may store mounting information of the multi-camera obtained during a camera calibration process of the vehicle 1, and parallax information which is geometric difference among the cameras of the multi-camera. The parallax information is based on positions among the cameras stored from an offline camera calibration (OCC) before shipment.

The memory 220 may be implemented with at least one of a volatile memory such as a random access memory (RAM), a non-volatile memory such as a cache, a flash memory, a read only memory (ROM), a programmable read only memory (PROM), an erasable programmable read only memory (EPROM), an electrically erasable programmable read only memory (EEPROM), etc., or a recording media such as a Hard Disk Drive (HDD), or a compact disc read only memory (CD-ROM), without being limited thereto.

The memory 220 and the processor 210 may be integrated into one chip, or provided as separate chips.

The controller 200 may include a communicator 230.

The communicator 230 may communicate with the plurality of cameras, the display, a brake device, a transmission device, a steering device, and the like.

The communicator 230 may include at least one constituent component facilitating communication between an external device and the constituent components of the vehicle 1, for example, at least one of a short-range communication module, wireless communication module, or a wired communication module. The short-range communication module may include a variety of short-range communication modules that transmit and receive signals in a short distance using a wireless communication network, such as a Bluetooth module, infrared communication module, radio frequency identification (RFID) communication module, wireless local access network (WLAN) communication module, near-field communication (NFC) communication module, Zigbee communication module, and the like. The wired communication module may include various wired communication modules such as a Controller Area Network (CAN) communication module, local area network (LAN) module, wide area network (WAN) module, value added network (VAN) module, or the like, and also include various cable communication modules such as a universal serial bus (USB), high definition multimedia interface (HDMI), digital visual interface (DVI), recommended standard 232 (RS-232), power line communication, plain old telephone service (POTS), or the like. The wired communication module may include a Local Interconnect Network (LIN). The wireless communication module may include wireless communication modules that support a variety of wireless communication methods such as a Global System for Mobile communication (GSM), Code Division Multiple Access (CDMA), wideband CDMA (WCDMA), Universal Mobile Telecommunications System (UMTS), Time Division Multiple Access (TDMA), Long Term Evolution (LTE), ultra wideband (UWB), and the like, in addition to a Wifi module and a Wibro module.

Hereinafter, for convenience of description, described is an example where a distance error to an object occurs due to a change in pose of the front surround view camera 130c including a front field of view among the surround view cameras 130.

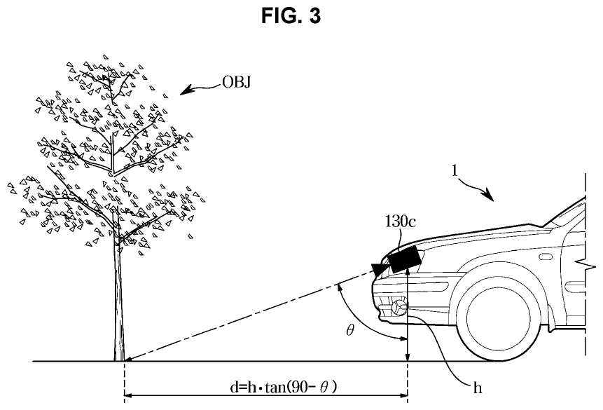

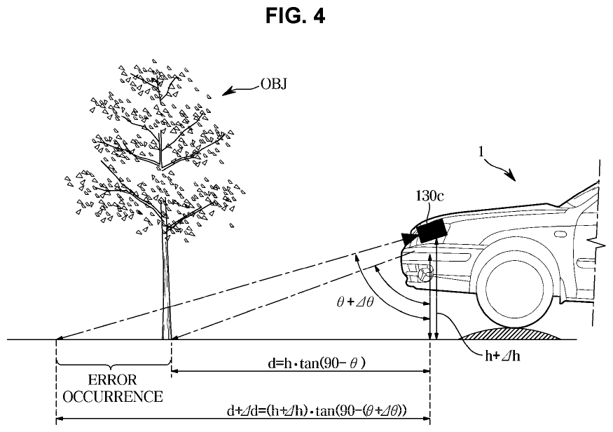

FIG. 3 and FIG. 4 are diagrams illustrating a distance error due to a change in pose of a vehicle according to an exemplary embodiment of the present disclosure.

Referring to FIG. 3 and FIG. 4, accurate location information of lanes and road markings around a vehicle is required in autonomous driving. Camera geometry is used for distance measurement of lanes and road markings. The camera geometry is a method of determining a distance to a recognized object using camera pose information.

When a pose of vehicle is changed, however, a pose of the camera mounted on the vehicle is changed as well. Accordingly, an accurate distance to the object may not be determined.

The vehicle 1 recognizes an object OBJ in an image of the front surround view camera 130c, and recognizes a distance to the object OBJ through image processing.

As shown in FIG. 3, the vehicle 1 requires a pose of the front surround view camera 130c based on a road surface to recognize a horizontal distance d to the object OBJ. The h is a height of the front surround view camera 130c from the ground and the 0 is an angle formed by arctangent between the height h and the horizontal distance d.

As shown in FIG. 4, a pose of the vehicle 1 may be changed by a topographical factor (a speed bump in FIG. 3), for example, a road with a speed bump or a pothole or an unpaved road. Also, a pose of the vehicle 1 may be changed by rapid acceleration/deceleration of the vehicle 1.

When a pose of the vehicle 1 is changed due to a rear wheel of the vehicle 1 passing the speed bump, a pose of the front surround view camera 130c of the vehicle 1 is also changed. Accordingly, an obtained image is also changed due to the change in pose of the front surround view camera 130c, and thus a distance error may occur in a horizontal distance between the object OBJ and the vehicle 1 recognized through the changed image. In the present instance, no change occurs in a pose relationship between the vehicle 1 and the front surround view camera 130c.

Therefore, to correct the distance error between the object OBJ and the vehicle 1 due to the change in pose of the vehicle 1, the change amount in pose of the front surround view camera 130c is required to be estimated, and the pose of the vehicle 1 is required to be estimated based on the change amount in pose of the front surround view camera 130c.

Hereinafter, for convenience of description, detecting a vanishing point using a front image input from the front camera 110 is described.

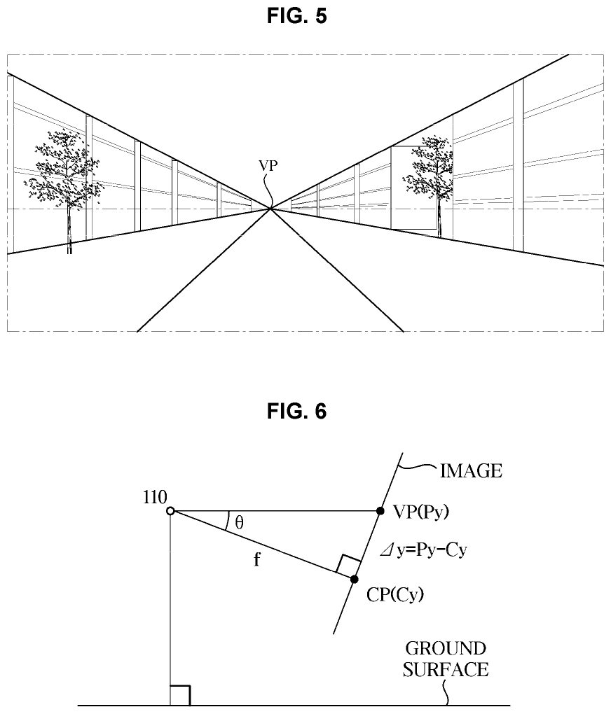

FIG. 5 is a diagram illustrating detecting a vanishing point in a front image by a vehicle according to an exemplary embodiment of the present disclosure.

Referring to FIG. 5, the controller 200 may detect all straight lines after correcting distortion in a front image obtained by the front camera 110.

A plurality of cross points where the plurality of straight lines cross may be vanishing point candidates. Any one of the cross points where the plurality of straight lines cross may be a vanishing point VP. When a road surface is even, a density of the vanishing point candidates may increase, and when a road surface is not even, a density of the vanishing point candidates may decrease. When a road surface is even, a position of a recognized vanishing point may converge to an ideal position. The even road surface refers to a flat road surface without a speed bump or a pothole. The uneven road surface refers to an unpaved road or a road with a speed bump or a pothole.

For example, the controller 200 may be configured to determine a cross point where the largest number of straight lines cross among the detected straight lines, and determine the cross point as a vanishing point VP. Accordingly, the vanishing point VP may be detected.

FIG. 6 is a diagram illustrating estimating the change amount in pose of a front camera based on a vanishing point in a front image by a vehicle according to an exemplary embodiment of the present disclosure.

Referring to FIG. 6, the controller 200 may estimate the change amount in pose of the front camera 110 based on a vanishing point VP and a center point CP corresponding to a principal point in an image of the front camera 110.

The vanishing point VP is a cross point where lines parallel to each other in a real world meet at one point due to a perspective effect when projected onto a front image. Accordingly, when a tilt of the front camera 110 is 0, the vanishing point appears on a same horizontal line as the center point CP. When a tilt of the front camera 110 is positive (+), the vanishing point appears below the center point CP, and when a tilt of the front camera 110 is negative (−), the vanishing point appears above the center point CP.

Accordingly, a position of a vanishing point in the front image is determined by a tilt of the front camera 110, and thus the tilt of the front camera 110 may be estimated by obtaining a y-axis coordinate of the vanishing point.

The controller 200 may recognize a y-axis coordinate Cy of the center point CP, and a y-axis coordinate Py of the vanishing point VP in the front image.

A distance Δy between the two coordinates may be obtained based on the y-axis coordinate Cy of the center point CP and the y-axis coordinate Py of the vanishing point VP.

Based on the distance (Δy=Py−Cy) between the y-axis coordinate Py of the vanishing point VP and the y-axis coordinate Cy of the center point CP and a focal length of the front camera 110 (focal lengths of cameras in f-axis direction and y-axis direction), a tilt angle of the front camera 110 (θ=a tan (Δy/f)) may be recognized. Here, the tilt angle of the front camera 110 corresponds to the change amount in pose of the front camera 110.

Accordingly, the controller 200 may estimate the change amount in pose of the front camera 110 based on the vanishing point VP and the center point CP of the front image.

A vanishing point is accurately detected when two parallel lanes exist. When two parallel lanes are not detected, however, the vanishing point may not be accurately detected, and thus the change amount in pose of the front camera may not be estimated accurately and reliably. Accordingly, a pose of vehicle may not be estimated accurately and reliably.

Thus, even when a vanishing point is not detected or is not accurately detected, accurate and reliable estimation of the change amount in pose of a camera is required to estimate a pose of vehicle accurately and reliably.

The vehicle according to various exemplary embodiments of the present disclosure may apply template matching to a monocular camera (e.g., a front camera) system or a multi-camera system, detecting the movement amount of a vanishing point, estimating the change amount in camera pose based on the movement amount of the vanishing point, and estimating a pose of the vehicle based on the change amount in camera pose.

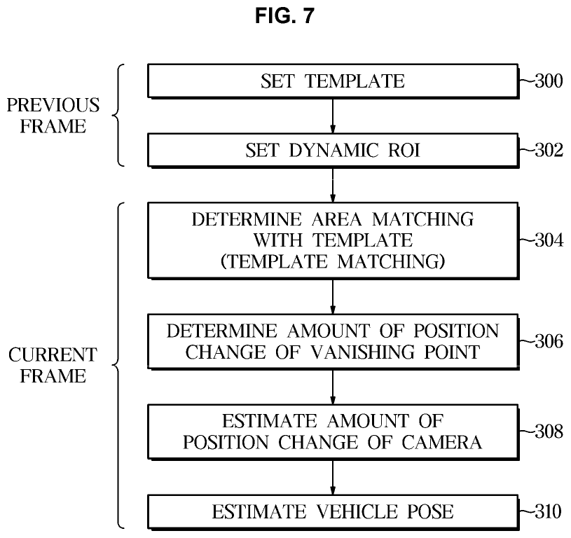

FIG. 7 is a flowchart illustrating a control method of a vehicle according to an exemplary embodiment of the present disclosure.

Referring to FIG. 7, the vehicle 1 may set, as a template, an area around a vanishing point in a previous frame of an image input from the front camera 110 (300).

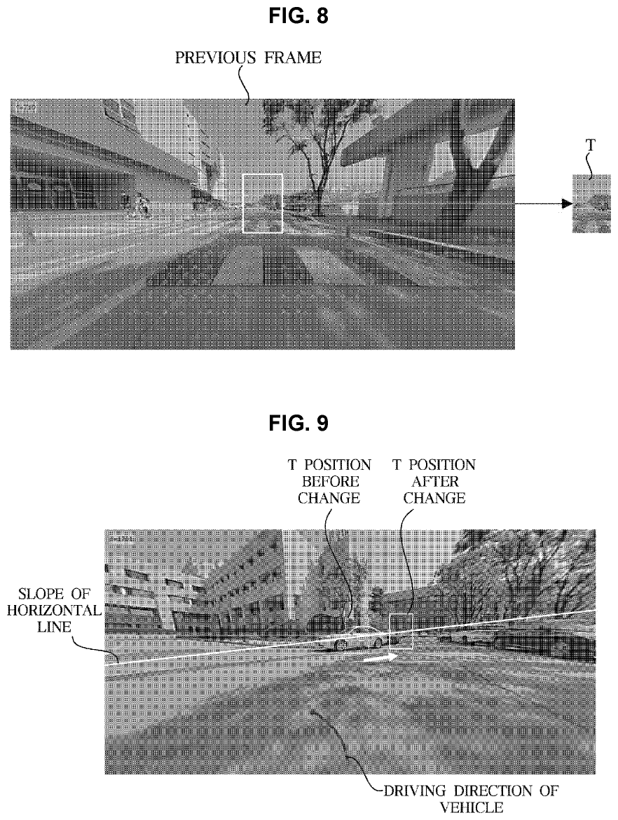

FIG. 8 is a diagram illustrating setting an area around a vanishing point as a template by a vehicle according to an exemplary embodiment of the present disclosure.

Referring to FIG. 8, the controller 200 may set, as a template, an area including a predetermined size and shape in an area around a vanishing point in a previous frame.

The controller 200 may be configured to determine the template to a current position or change a position of the template to another position, based on a reliability of the template.

The controller 200 may be configured to determine the reliability of the template based on a variance value of the template. A low variance value indicates a low contrast and a single color. When the template is a monochromatic, no feature exists. Accordingly, template matching to the template may be less accurate. For example, because a blue sky has no feature, template matching may not be performed with respect to a same area in a current frame. When only one cloud exists in a middle of the blue sky, where the cloud is located may be identified in a current frame, and thus a variance value increases and template matching may be performed.

Accordingly, a variance value of grayscale of the template may be determined, and the reliability of the template may be determined based on the variance value of the template. When a variance value of the template is greater than a predetermined reference value (reference variance value), it may be determined that the reliability of the template is high, and when a variance value of the template is lower than the predetermined reference value, it may be determined that the reliability of the template is low.

When a variance value of the template is greater than the predetermined reference value, the reliability of the template is high, and thus the template is determined to a current position.

However, when a variance value of the template is lower than the predetermined reference value, the reliability of the template is low, and thus the template may be changed to another position.

Variance values of all areas in an image refer to a degree of contrast of the image. A variance value of a template refers to a degree of contrast of the template. Accordingly, when a contrast of a template is lower than that of an image, a position of the template is required to be moved.

FIG. 9 is a diagram illustrating changing a position of a template by a vehicle according to an exemplary embodiment of the present disclosure.

Referring to FIG. 9, the vehicle 1 may be configured to determine a movement direction of a template based on a roll angle at which the front camera 110 is mounted and a driving direction of the vehicle 1, and move the template to the determined movement direction.

When a driving direction of the vehicle 1 is known, a position of the template is moved along a slope of a horizontal line.

The slope of the horizontal line may be confirmed from a mounting posture of the front camera 110. The slope of the horizontal line is determined according to the roll angle at which the front camera 110 is mounted. The slope of the horizontal line occurs according to the roll angle at which the front camera 110 is mounted. In general, because a vanishing point exists on a horizontal line, a position of the template is moved along the horizontal line.

Accordingly, when the mounting posture of the front camera 110 and the rotation amount (or direction of rotation) of the vehicle are known, an ideal position of the vanishing point may be determined. A driving direction of the vehicle may be known from a trajectory of the front camera 110 or a steering angle signal.

When turning left, the vehicle 1 moves the template to a right side of the slope of the horizontal line. Accordingly, the vanishing point is moved to the right.

When turning right, the vehicle 1 moves the template to a left side of the slope of the horizontal line. Accordingly, the vanishing point is moved to the left.

When going straight, the vehicle 1 moves the template upwards. When the template is moved downward, which is mostly a road surface, the template is moved to an area adjacent to the vehicle 1. Because a vanishing point refers to a point separated from the vehicle 1 by an infinite distance, when the template is closer to the vehicle 1, an error may increase.

A size of the template may vary depending on a speed of the vehicle 1. For example, as the speed of the vehicle increases, the size of the template may increase upwards and/or left and right.

Meanwhile, when a driving direction of the vehicle 1 is unknown, a position of the template is moved upward than a current position.

Referring again to FIG. 7, the vehicle 1 may set a dynamic region of interest (dynamic ROI) based on the template in a previous frame (302).

The controller 200 may set an area including the template in the previous frame as the dynamic ROI.

The controller 200 may include the template in the dynamic ROI and set the dynamic ROI to be greater than the template.

The vehicle 1 may perform template matching on the dynamic ROI in a current frame to determine a matching area matching with the template (304).

The previous frame and the current frame may be consecutive frames.

Template matching is a method of finding a position of a provided image in an entire image, when a small partial image is given. That is, the template matching is a method of matching through comparison of the entire image with a template which is the partial image to be tracked.

The template matching may be performed by use of a normalized cross correlation (NCC) matching method. The NCC matching method is for finding normalized correlation, and may measure a linear difference in brightness values and a geometric similarity between an input image and a template. A value including a largest correlation coefficient may be a movement amount of the template.

Furthermore, the template matching may use a squared difference matching method, a correlation matching method, and correlation coefficient matching method, and the like. In the squared difference matching method, a sum of squared differences is determined while moving a template T in a search area I. The sum is small at a matching position. When the template and an input image perfectly match, 0 is returned, but when the two do not match, the sum increases. In the correlation matching method, products of a template and an input image are squared and added together. The sum is large at a matching position. When the template and the input image perfectly match, the sum is large, and when the two do not match, the sum is small or 0. The correlation coefficient matching method considers an average of each of a template and input image. When the template and the input image perfectly match, 1 is returned, and when the two do not match completely, −1 is returned. When no correlation exist at all between the two images, 0 is returned.

The vehicle 1 may perform template matching with respect to the template and the dynamic ROI in the current frame, determining a matching area matching with the template. The matching area matching with the template may be an area with a highest similarity to the template (an area where a correlation coefficient is greater than or equal to a preset value) among the dynamic ROI (or an entire area).

The vehicle 1 may be configured to determine the amount of position change of vanishing point based on the amount of position change between the template and the matching area (306).

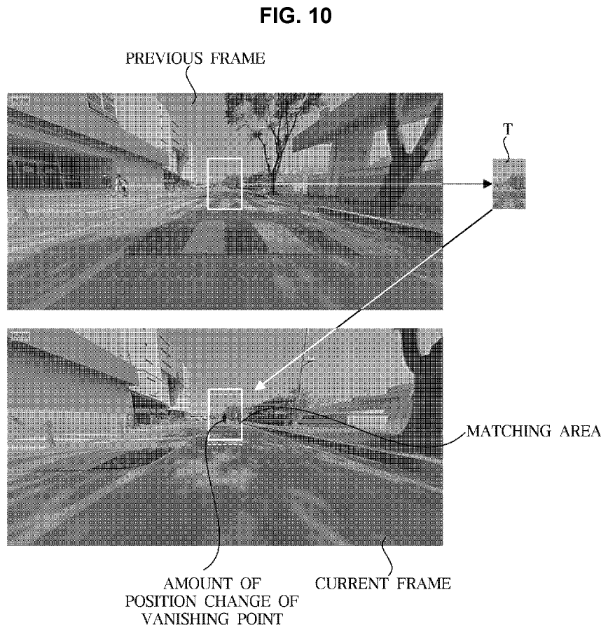

FIG. 10 is a diagram illustrating determining the amount of position change of a vanishing point by performing template matching in a vehicle according to an exemplary embodiment of the present disclosure.

Referring to FIG. 10, the controller 200 may set the area around the vanishing point in the previous frame as the template T, and then determine the matching area by performing template matching in the current frame.

Also, the controller 200 may compare coordinates of the position of the template of the previous frame and the matching area in the current frame. When the coordinates are different as a result of comparison, the controller 200 may assume that the vanishing point has moved by the difference. In the present instance, only the movement of an x-axis and y-axis of the vanishing point may be considered.

Accordingly, the amount of position change of the template indicating the amount of position change of the vanishing point may be confirmed, and thus the amount of position change of the vanishing point may be known.

Referring again to FIG. 7, the vehicle 1 may estimate the amount of position change of the front camera 110 based on the amount of position change of the vanishing point (308).

The controller 200 may estimate the change amount in a pose of the camera based on the amount of position change of the template.

The controller 200 may be configured to determine the amount of pitch change among the change amount in pose of the camera, based on the amount of position change of the vanishing point which is the amount of position change of the template.

Mostly, a moving object moves left and right in an image. Accordingly, when a moving object is included in the template, it may be erroneously determined that the vehicle 1 moves left and right.

By contrast, mostly, a moving object does not move up and down. Accordingly, only the movement amount in vertical direction is used among results of template matching. The movement amount in vertical direction indicates pitch, estimating the amount of pitch change among the change amount in pose of the camera.

When the change amount in a pose of the camera is estimated based on the amount of position change of the template, the controller 200 removes the change amount in y-axis of the template by a roll slope at which the front camera 110 is mounted, to have an effect of rotating the image by a roll angle of the front camera 110. The roll slope of the front camera 110 may be confirmed through camera calibration after the front camera 110 is mounted. For example, when an image is photographed after tilting a roll of a portable camera by 30 degrees and then shaking up and down, the photographed image is shaken in a direction twisted by −30 degrees instead of up and down directions. This is required to be removed by image processing for pitch estimation.

Afterwards, the remaining change amount in y-axis of the template is assumed as the change amount in y-axis of the vanishing point.

The controller 200 may estimate the amount of pitch change of the front camera 110 based on the change amount in y-axis of the vanishing point.

Referring again to FIG. 7, the vehicle 1 may estimate a pose of the vehicle 1 according to the amount of position change of the front camera 110 (310).

The controller 200 may estimate a pitch of the vehicle 1 based on the amount of pitch change of the front camera 110. Because the front camera 110 is mounted on the vehicle 1, a camera coordinate system and a vehicle coordinate system have a rigid transform relationship. In the rigid transform, only direction and position may be changed while keeping a same size and shape. Accordingly, because rotation values of the pose of the front camera 110 and the pose of the vehicle 1 are equal to each other, the pitch of the vehicle 1 may be estimated based on the amount of pitch change of the front camera 110.

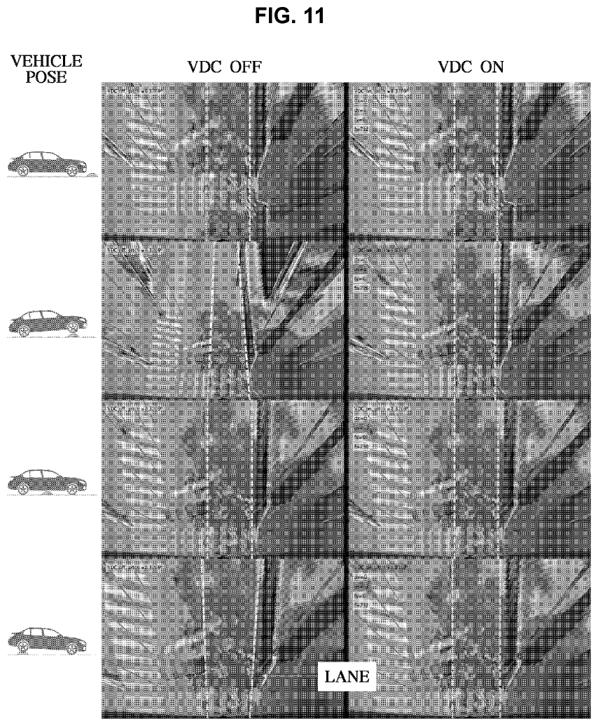

FIG. 11 are top view images when a vehicle pose estimated using template matching is applied and is not applied, in a vehicle according to an exemplary embodiment of the present disclosure.

Referring to FIG. 11, illustrated are a top view image (right image) when a pose of the vehicle 1, estimated using template matching by the vehicle 1 while the pose of the vehicle 1 is changed during passing of a speed bump, is applied (VDC is in operation), and a top view image (left image) when a pose of the vehicle 1 estimated using template matching is not applied (VDC is not in operation).

The pose of the vehicle 1 is changed when passing the speed bump, and thus it may be confirmed that parallel lanes are misaligned.

When the VDC is in operation, a changed pose of the vehicle 1 is estimated, and thus it may be confirmed in the top view image that the lanes are parallel even when the vehicle 1 passes the speed bump. It may be confirmed that the misaligned lanes appearing when front wheels and rear wheels of the vehicle 1 pass the speed bump become parallel, when the VDC is on.

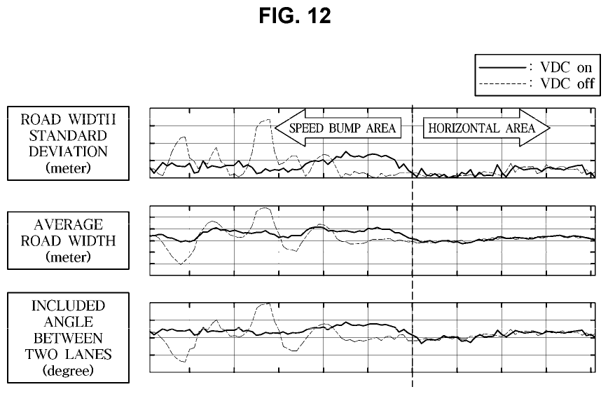

FIG. 12 illustrates a road width standard deviation, an average road width, and an included angle between two lanes when a vehicle pose estimated using template matching is applied and is not applied, in a vehicle according to an exemplary embodiment of the present disclosure.

Referring to FIG. 12, illustrated are a road width standard deviation, an average road width, and an included angle between two lanes when a pose of the vehicle 1, estimated using template matching by the vehicle 1 while the pose of the vehicle 1 is changed during passing of a speed bump, is applied (VDC on), and a road width standard deviation, an average road width, and an included angle between two lanes when a pose of the vehicle 1 estimated using template matching is not applied (VDC off).

It may be confirmed that a maximum value and a minimum value of each of the road width standard deviation, the average road width, and the included angle between two lanes are significantly large, when VDC is not in operation while the vehicle 1 passes a speed bump. When VDC is in operation, however, the maximum value and the minimum value of each of the road width standard deviation, the average road width, and the included angle between two lanes are significantly decreased, which indicates that VDC is stably operated even when a vanishing point is not detected.

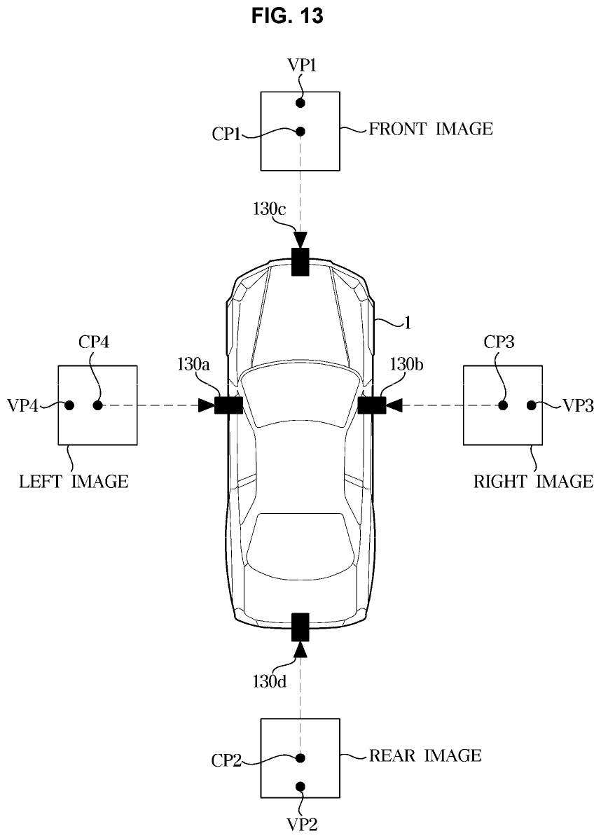

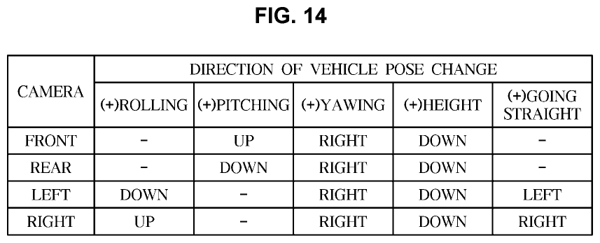

FIG. 13 is a diagram illustrating estimating a pose of a vehicle using multi-cameras by the vehicle according to another exemplary embodiment of the present disclosure. FIG. 14 is a diagram illustrating a relationship between a movement direction of vanishing point for each camera and a pose of a vehicle in the vehicle according to another exemplary embodiment of the present disclosure.

Referring to FIGS. 13 and 14, a disadvantage of using a single camera may be overcome by multi-camera-based VDC.

The multi-camera-based VDC fuses the change amount of vanishing point in each camera for improvement of performance.

The four cameras 130a, 130b, 130c and 130d are used to recognize all directions of the vehicle 1, and the change amount of vanishing point of each of the cameras is estimated using template matching. Also, by fusing information related to the change amount of vanishing point of each of the cameras, a pose of the vehicle is estimated.

When a pose or a position of the vehicle 1 is changed, a movement direction of a template is different for each camera, which is illustrated in FIG. 14. A relationship among a movement direction of vanishing point for each of the cameras and a pose of the vehicle (rolling, pitching, yawing, height, going straight, etc.) is illustrated in FIG. 14.

After removing an error component by use of the above features, the pose of the vehicle may be estimated.

Template matching includes various error components. To limit a range of error component, it is assumed that a moving object does not move vertically, because most of the objects recognized around the vehicle in motion, such as other vehicles, pedestrians, buildings, and the like, do not move vertically. Even when no vertical movement is assumed, a vertical movement may be detected when a height of a vehicle is changed. Accordingly, a common component among vertical movement components of all cameras is assumed as a component due to vertical movement.

When the vehicle 1 is moving, a horizontal component is generated in the left and right cameras 130a and 130b. Accordingly, common components different from each other are assumed as an error component due to driving. After removing the above error component, the pose of the vehicle is estimated.

Pitching may be estimated from the front and rear cameras 130c and 130d, rolling may be estimated from the left and right cameras 130a and 130b, and yawing may be estimated from the four cameras 130a, 130b, 130c and 130d.

Because the front camera 130c and the rear camera 130d have opposite viewing directions, template movement directions of the front camera 130c and the rear camera 130d are expressed opposite to each other for the same change in pose of a vehicle.

For example, when pitching (pose) of the vehicle changes in a (+) direction, a template of the front camera 130c moves upward and a template of the rear camera 130d moves downward. Accordingly, it may be assumed that a component including different directions in the movement amount of the templates of the front and rear cameras 130c and 130d is a pitch change component of the vehicle. When the same method is applied to the left and right cameras 130a and 130b, rolling (pose) of the vehicle may be estimated.

To estimate yawing (pose) of the vehicle 1, horizontal components of all the cameras are used. When a yaw pose of the vehicle changes, a horizontal component is generated in templates of all the cameras as a result of template matching of each of the cameras. Accordingly, the same horizontal movement component in the results of template matching of the four cameras may be used to estimate a yaw pose.

As described above, according to an exemplary embodiment of the present disclosure, a pose of a vehicle may be estimated in real time by use of a monocular camera system or multi-camera system together with template matching. According to an exemplary embodiment of the present disclosure, a pre/post processing required in existing technologies may be omitted. Unlike existing technologies which may estimate a vehicle pose only when a lane is clear in a straight section, the present disclosure may appropriately perform vehicle pose estimation without being affected by a driving environment. Also, because the multi-camera system is used in an exemplary embodiment of the present disclosure, a redundancy system capable of estimating a vehicle pose even when a portion of cameras are not operated may be built.

As is apparent from the above, according to the exemplary embodiments of the present disclosure, the vehicle and the control method thereof can estimate the change amount in camera pose using template matching on a vanishing point in an image, estimating a pose of the vehicle more accurately and reliably.

Meanwhile, the aforementioned controller and/or its constituent components may include at least one processor/microprocessor(s) combined with a computer-readable recording medium storing a computer-readable code/algorithm/software. The processor/microprocessor(s) may execute the computer-readable code/algorithm/software stored in the computer-readable recording medium to perform the above-descried functions, operations, steps, and the like.

The aforementioned controller and/or its constituent components may further include a memory implemented as a non-transitory computer-readable recording medium or transitory computer-readable recording medium. The memory may be controlled by the aforementioned controller and/or its constituent components and configured to store data, transmitted to or received from the aforementioned controller and/or its constituent components, or data processed or to be processed by the aforementioned controller and/or its constituent components.

The included embodiment may be implemented as the computer-readable code/algorithm/software in the computer-readable recording medium. The computer-readable recording medium may be a non-transitory computer-readable recording medium such as a data storage device configured for storing data readable by the processor/microprocessor(s). For example, the computer-readable recording medium may be a Hard Disk Drive (HDD), a solid state drive (SSD), a silicon disk drive (SDD), a read only memory (ROM), a compact disc read only memory (CD-ROM), a magnetic tape, a floppy disk, an optical recording medium, and the like.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control method of a vehicle, the control method comprising:
setting, as a template, an area around a vanishing point in a previous frame of an image input from a camera;
determining, by a controller, a matching area matching with the template by performing template matching in a current frame;
determining, by the controller, an amount of position change of the vanishing point based on an amount of position change between the template and the matching area;
estimating, by the controller, a change amount in a pose of the camera based on the amount of position change of the vanishing point; and
estimating, by the controller, a pose of the vehicle depending on the change amount in pose of the camera.

2. The control method of claim 1, wherein the setting of the area around the vanishing point as the template includes changing a position of the template based on a variance value of the template.

3. The control method of claim 2, wherein the setting of the area around the vanishing point as the template includes:
determining a reliability of the template based on the variance value of the template; and
changing the position of the template, based on the reliability of the template being low.

4. The control method of claim 2, wherein the changing of the position of the template includes moving the template according to a slope of a horizontal line based on a roll angle at which the camera is mounted.

5. The control method of claim 4, wherein the changing of the position of the template includes moving the template according to the slope of the horizontal line in a direction opposite to a driving direction of the vehicle.

6. The control method of claim 2, wherein the changing of the position of the template includes moving the template upward, based on a driving direction of the vehicle not being recognized or the vehicle going straight.

7. The control method of claim 1, wherein the setting of the area around the vanishing point as the template includes changing a size of the template based on a speed of the vehicle.

8. The control method of claim 1, wherein the determining of the matching area includes performing the template matching using a normalized cross correlation matching.

9. The control method of claim 8, wherein the determining of the matching area includes performing the template matching using the normalized cross correlation matching in the current frame consecutive from the previous frame.

10. The control method of claim 1,
wherein the camera is a front camera configured to obtain image data for a field of view facing a front of the vehicle, and
wherein the determining of the amount of position change of the vanishing point includes:
determining a change amount in y-axis of the template based on the amount of position change between the template and the matching area, and
determining a change amount in y-axis of the vanishing point based on a change amount in y-axis where a roll slope at which the front camera is mounted is compensated from the change amount in y-axis of the template.

11. The control method of claim 10, wherein the estimating of the change amount in the pose of the camera includes estimating an amount of pitch change of the front camera based on the change amount in y-axis of the vanishing point.

12. The control method of claim 11, wherein the estimating of the pose of the vehicle includes estimating a pitch pose of the vehicle based on the amount of pitch change of the front camera.

13. The control method of claim 1,
wherein the camera is a multi-camera configured to obtain image data for a field of view facing a plurality of directions of the vehicle, and
wherein the estimating of the change amount in the pose of the camera includes:
fusing an amount of position change of a vanishing point corresponding to each camera of the multi-camera,
estimating a change amount in pose of each of the cameras of the multi-camera based on the fused amount of position change of the vanishing point, and
estimating the pose of the vehicle based on the estimated change amount in the pose of each of the cameras.

14. The control method of claim 13, wherein the estimating of the pose of the vehicle includes estimating the pose of the vehicle as at least one of rolling, pitching, yawing, height, or going straight.

15. A vehicle, comprising:
a camera configured to photograph an area around of the vehicle; and
a controller electrically connected to the camera,
wherein the controller is configured to:
set, as a template, an area around a vanishing point in a previous frame of an image input from the camera,
determine a matching area matching with the template by performing template matching in a current frame,
determine an amount of position change of the vanishing point based on an amount of position change between the template and the matching area,
estimate a change amount in a pose of the camera based on the amount of position change of the vanishing point, and
estimate a pose of the vehicle depending on the change amount in pose of the camera.

16. The vehicle of claim 15, wherein the controller is configured to change a position of the template based on a variance value of the template.

17. The vehicle of claim 16, wherein the controller is configured for determining a movement direction of the template based on a driving direction of the vehicle and a roll angle at which the camera is mounted, and for moving the template in the determined movement direction.

18. The vehicle of claim 15,
wherein the camera is a front camera configured to obtain image data for a field of view facing a front of the vehicle, and
wherein the controller is configured to:
determine a change amount in y-axis of the template based on the amount of position change between the template and the matching area,
determine a change amount in y-axis of the vanishing point based on a change amount in y-axis where a roll slope at which the front camera is mounted is compensated from the change amount in y-axis of the template,
estimate an amount of pitch change of the front camera based on the change amount in y-axis of the vanishing point, and
estimate a pitch pose of the vehicle based on the amount of pitch change of the front camera.

19. The vehicle of claim 15,
wherein the camera is a multi-camera configured to obtain image data for a field of view facing a plurality of directions of the vehicle, and
wherein the controller is configured to:
fuse an amount of position change of a vanishing point corresponding to each camera of the multi-camera,
estimate a change amount in pose of each of the cameras of the multi-camera based on the fused amount of position change of the vanishing point, and
estimate the pose of the vehicle based on the estimated change amount in the pose of each of the cameras.

20. The vehicle of claim 19, wherein the controller is configured for estimating the pose of the vehicle as at least one of rolling, pitching, yawing, height, or going straight.
